(19) United States
(12) Patent Application Publication
(10) Pub. No.: US 2026/0062238 A1
(43) Pub. Date: Mar. 5, 2026

(54) DEVICE AND METHOD FOR EMPTYING CONTAINERS

(71) Applicant: Alpha-Protein GmbH, Bruchsal (DE)

(72) Inventor: Rohi Shalati, Karlsruhe (DE)

(21) Appl. No.: 18/997,651

(22) PCT Filed: May 16, 2023
(86) PCT No.: PCT/DE2023/100360

§ 371 Date: Jan. 22, 2025

(30) Foreign Application Priority Data
Jul. 22, 2022 (DE) 10 2022 118 456.0

(51) Int. Cl. B65G 65/34; B65G 69/08

(52) U.S. Cl. CPC B65G 65/34; B65G 69/08; B65G 2203/0216; B65G 2203/0258; B65G 2203/041

(57) ABSTRACT

Producing cost-effective, protein-rich and sustainable sources for the food and feed industries is one of the challenges of the new millennium, especially given the world's ever-growing population. The object of the invention presented here is to ensure the assignability and traceability of material flow during the emptying of containers. This object is achieved with the apparatus according to the invention in that it has a measuring device, by means of which data about the at least one container to be emptied and/or the container contents can be collected prior to, during and/or after the emptying process.

### REFERENCE TO PENDING PRIOR PATENT APPLICATIONS

This patent application is a 371 national stage entry of pending prior International (PCT) Patent Application No. PCT/DE2023/100360, filed 16 May 2023 by Alpha-Protein GmbH for DEVICE AND METHOD FOR EMPTYING CONTAINERS, which patent application, in turn, claims benefit of German Patent Application No. 10 2022 118 456.0, filed 22 Jul. 2022. The two (2) above-identified patent applications are hereby incorporated by reference.

### FIELD OF THE INVENTION

The invention relates to an apparatus and a method for emptying containers. The apparatus comprises a container inserting device for inserting at least one container to be emptied, a container emptying device for emptying the at least one container, a container ejecting device for ejecting the at least one emptied container, a container conveying device for transporting the at least one container to be emptied and/or emptied, along with a conveying device for transporting the at least one container content emptied from the container and/or a collecting device for collecting the container contents emptied from the at least one container. Furthermore, the invention relates to a method for emptying containers along with the use of an apparatus according to the invention for emptying containers, in particular with insect breeding.

### BACKGROUND OF THE INVENTION

From DE 677 253 A, an apparatus of the type mentioned above is already known, namely a tilting apparatus, in particular for milk cans. This comprises a distribution apparatus with which the milk cans to be emptied are allocated for emptying. The milk cans are emptied by a carrier, ejected after emptying and picked up by a carrying basket unit. The milk emptied from the milk cans is collected in a trough and the milk cans are weighed before emptying.

Furthermore, DE 10 2008 029 663 A1 discloses an apparatus and a method for tracing waste materials from waste containers, which deals with the traceability of the material flow of waste materials. The described apparatus solves its technical problem by detecting the waste container to be emptied, storing the data collected here, and, after shredding and interim storage of the waste, taking a sample of it and assigning this sample to the previously stored data. Thus, a seamless documentation and clear assignment of the waste material generated by the producer to a specific waste material container are made possible.

However, interim storage of the shredded waste is necessary, along with a sampling unit in order to ultimately ensure clear assignment, which in turn results in greater equipment expenditure and thus causes higher costs and is more time-intensive.

Furthermore, from DE 10 2015 004 256 A1 an apparatus for tilting dimensionally stable containers, in particular waste containers for emptying them, is already known, the object of which is to allow containers to be tilted safely.

Producing cost-effective, protein-rich and sustainable sources for the food and feed industries is one of the challenges of the new millennium, especially given the world's ever-growing population. The automated breeding of insects, vegetables, sprouts and mushrooms has proven to be an innovative approach providing a cost-efficient and sustainable food source that can be used in both the food and feed industries. These sustainable sources can represent real alternatives if they can compete with conventional feed and food sources in terms of produced sales volumes, nutritional content and economic decision criteria. This is achieved through the automation of production, which allows scaling by applying the principles of Industry 4.0 to agricultural technology.

With the forerunners of this change, namely “vertical farming” and the use of insects, it is clear that in the future the continuous “tracking” of products and goods within a fully automated factory will become increasingly important. Here, the monitored transition from piece goods, such as, for example, the transport of goods as contents of containers and/or plant containers, to the transport of these goods as bulk goods, which are transported, for example, on a conveyor belt, has proven to be essential within the framework of quality assurance, monitoring and continuous optimization of biological and technical processes.

In this connection, Chinese utility model CN 209711168 U proposes an apparatus for rotating containers. This comprises a container feeding device, a container rotating device and a container ejecting device. The container feeding device comprises a profile frame, a conveyor belt and a container pushing apparatus. By means of a guiding device, the incoming containers conveyed by the container feeding device are directed in the provided direction. Once the containers have arrived at the container rotating apparatus, they are pushed into the container rotating apparatus by the container pushing apparatus and turned over by the container rotating apparatus. The contents falling out of the containers are directed via a funnel onto a conveyor belt arranged below the container rotating apparatus and the material is transported by the conveyor belt to the next process step. The emptied container is conveyed to the container ejecting device and ejected from the apparatus.

However, the apparatus for rotating containers disclosed in the utility model lacks an assignment of the emptied container contents to the previously conveyed container. However, since the condition of the container contents can differ from container to container, for example due to the growth stage of the living creatures, such as insects, located inside the boxes of the container to be emptied, the object of the invention described here is to be able to guarantee a corresponding assignment at any time. In other words, the object of the apparatus and method according to the invention is to ensure traceability of the material flow after a container has been emptied.

This object is achieved with an apparatus according to the independent claim 1. Furthermore, the object is achieved by the independent method claim 25 and the use claim 35. Advantageous embodiments of the invention can be found in the dependent claims.

In a first aspect, the invention relates to an apparatus for emptying individual or palletized containers, which comprises a container inserting device for inserting at least one container to be emptied into the container emptying device, a container emptying device for emptying the at least one container, a container ejecting device for dispensing the at least one emptied container, a container conveying device for transporting the at least one container to be emptied and/or emptied, and a conveying device for transporting a container content emptied from the container and/or a collecting device for collecting the container contents emptied from the at least one container.

### SUMMARY OF THE INVENTION

For achieving the object according to the invention, the invention proposes that the apparatus has at least one measuring device, with which measurement data can be collected from the at least one container and/or the container contents prior to, during and/or after the emptying of the container and these data collected by the at least one measuring device can be assigned to the container contents emptied by the container emptying device onto the conveying device and/or into the collecting device. It is also conceivable that the contents of a container are not assigned to the individual container, but to a batch of containers and/or a pallet of containers.

This means that, in addition, the position of the container contents in or on the downstream conveyor medium or in the collection medium can be monitored, or instructions for action for transport to specific downstream processing and handling stations or locations, or for the subsequent process itself, can be derived.

Thus, the measurement data collected in this way can be accessed in a subsequent processing step and the respective downstream process step can be adapted to the present data situation.

In a further advantageous embodiment, the at least one measuring device, which is preferably arranged on the container inserting device, has at least one sensor and/or at least one optical detecting device for collecting measurement data of the container to be emptied and/or the container contents. The at least one measuring device can be arranged in a stationary position and/or can move over part of the path with the moving container to be emptied and, in a further advantageous embodiment, can also be inserted into the stationary and/or moving container and/or the container contents in order to collect data that must be collected by contact or a short distance from the object to be measured. The data to be collected can be, for example, temperature, thermal radiation, humidity, fill level or an entire surface profile, degree of maturity in insects, coloration, etc. It is also conceivable that, by means of the optical detecting device, which can be a camera in the visible spectrum, the condition of the contents of the container, in particular insects, in particular their growth stage, size distribution, activity, color, health, distribution in the container, etc., can be determined.

Furthermore, in a further advantageous embodiment, the apparatus has a weighing device with which, for example, the container to be inserted by the container inserting device into the container emptying device can be weighed before insertion into the container emptying device. In combination with the filling level or the entire surface profile, the density of the container contents can be ascertained, for example.

In a further advantageous embodiment, the measuring device has an identification device with which an identification element present on the at least one container, at least one batch of containers and/or at least one pallet of containers can be detected and thus the identity of the at least one container, the at least one batch of containers and/or the at least one pallet of containers can be clearly determined and the container contents can be assigned to these. Any information received can thus be clearly assigned to a container, a batch of containers and/or a pallet of containers. For example, a QR code could be used as an identification element and a QR code reader as an identification device. However, simple versions of identification elements in the form of bar codes, notches in the container, etc. are also conceivable. If the container identification does not take place in the apparatus itself, it is also conceivable that, in an alternative embodiment, the corresponding information for identifying the at least one container, the at least one batch of containers and/or the at least one pallet of containers is collected by a device upstream of the apparatus and transmitted to the apparatus itself. This upstream device can, for example, be a destacking or container separating device that is connected upstream of the apparatus according to the invention.

Preferably, the apparatus according to the invention has an interface to a conveying and/or buffering device in order to be able to connect the apparatus to a conveyor system and/or a buffering device. Particularly preferably, the apparatus itself has a buffering device from which at least one stored container, at least one batch of containers and/or at least one pallet of containers can be inserted into the apparatus according to the invention via a conveying device, in particular the container conveying device.

In a further advantageous embodiment, the apparatus has an upstream and/or downstream container separating device, with which at least one stack, one batch and/or one pallet of containers can be separated and fed to the container conveying device and, after emptying the separated containers, can be received by the container conveying device and stacked again by the container separating device into a stack, a batch of containers and/or a pallet of containers.

In order to be able to obtain any information about the at least one container emptied by the container emptying device, the apparatus provides in a further advantageous embodiment that a measuring device for collecting data of the at least one emptied container is arranged on the container ejecting device. In the event that the at least one container is, for example, damaged, shows excessive wear or was damaged or not completely emptied during the emptying by the container emptying device, this can be determined by means of the measuring device arranged on the container ejecting device. Particularly advantageously, the measuring device on the container ejecting device has at least one sensor, for example a scale, which detects the weight of the emptied container, and/or at least one optical detecting device, in particular a camera, for collecting the data relevant for this purpose.

In a further advantageous embodiment, the invention provides for the apparatus that a measuring device for collecting data prior to, during and/or after the emptying process is arranged on the container emptying device. Data that may be of interest during emptying include, for example, the quantity and number of container contents emptied, the piece or grain size and composition and distribution of the container contents, the speed at which the container contents are emptied, along with any other parameters that may occur in this connection.

Particularly preferably, in an advantageous embodiment of the apparatus according to the invention, the conveying device is a continuous and/or discontinuous conveying device, such as, for example, a conveyor belt and/or a driverless transport system. Driverless transport systems are, for example, driverless transport vehicles, which represent a floor-bound conveying means with its own travel drive that is automatically controlled and guided without contact.

Furthermore, in an advantageous embodiment of the container emptying device, the invention provides that the at least one container is rotated by a rotating device, so that the at least one container can be emptied and the container contents can be fed onto the conveying device. It is also conceivable that, after the rotation and emptying of the at least one container by the rotating device, the container emptying device rotates the at least one container back again before further conveyance by the container ejecting device or transfers it in the rotated position to the container ejecting device. Preferably, the at least one container is not rotated by the rotating device by an angle of 90° to 270°, for example 180°, but by an angle between 90° and 180°, whereby any necessary turning of the container back to the starting position can be achieved more quickly due to the shorter step path, wherein the angle for complete emptying can be adapted to the container height, the content and the rotational speed, or is preset. In an alternative embodiment, the container is rotated by the rotating device by an angle of 90° to 270°, for example 180°, and the container is transferred to the container ejecting device in its 180° rotated position. In a further alternative embodiment, the container is rotated by 270° to 450°, particularly advantageously by 360°, so that a reversal of the direction of rotation is avoided. In other words, the container is preferably rotated completely once around one of its axes.

In an alternative embodiment, the container emptying device has a removal device, for example a suction device, with which the container contents can be removed from the at least one container by suction and transferred to the conveying device or inserted into the collecting device. In this case, the at least one container can be transferred from the container emptying device to the container ejecting device without changing its position, wherein this in turn positively affects the efficiency and speed of emptying the at least one container.

In order to ensure that all container contents have been removed from the at least one container by the container emptying device, in an advantageous embodiment the invention provides that the container emptying device has a residue emptying device with which in particular any residue that may be present can be removed from the at least one emptied container. This can, for example, have a shaking, tapping, vibration, high-pressure jet or brushing device or a combination of the aforementioned devices, with which the at least one container to be emptied can be processed prior to, during and/or after the emptying process, so that any residue that may be present can be released and removed from the at least one container, wherein this residue is preferably transferred to the conveying device or inserted into the collecting device.

In a further advantageous embodiment, the apparatus has a cleaning unit that prevents contamination of the at least one container to be emptied or emptied, in particular between individual batches, by removing any residue that may be present in the apparatus. This can be achieved, for example, by an integrated high-pressure cleaning system, which is directed at contaminated regions of the apparatus, for example the container emptying device and/or the conveying device. In an alternative embodiment, cleaning can be carried out by means of air or water pressure or other suitable fluids, with or without cleaning agents, or mechanically.

In order for the container contents, in particular the insects to be removed from the at least one container, to reach the conveying device in the most targeted, gentle and bundled manner possible, the invention provides in a further advantageous embodiment that the container emptying device has a guiding device that makes possible a particularly gentle reception and transfer of the container contents and is preferably adapted to the corresponding goods. This can be achieved, for example, by a particularly soft lining of the guiding device and/or by a correspondingly adapted geometry of the guiding device, with which the impact of the bulk goods can be absorbed, for example, by a very steep, parabolically flattening angle. Alternatively, this can also be achieved by a generated air flow, in particular one opposing the falling direction of the bulk goods, which airflow dampens the impact of the bulk goods, i.e., the container contents. It is also conceivable that the guiding device is driven and thus allows a very gentle, not exclusively gravimetric, transport of the emptied container contents. This could be achieved, for example, by vibration conveying or pneumatic/hydraulic conveying.

Since the container contents can sometimes contain fine particles, for example from substrate, feed residues, etc., and thus emptying the container can lead to the formation of dust, the invention provides, in a further advantageous embodiment, that it has a device for complying with ATEX regulations. Preferably, the device is an ignition source analysis device, an ignition source prevention device, a dust precipitation device and/or a purge air device, with which dust discharge can be reduced according to ATEX regulations.

In a second aspect, the invention relates to a method for emptying at least one container, in particular with an apparatus according to the invention. A container to be emptied is conveyed from a container conveying device to a container inserting device and inserted by a container inserting device into a container emptying device, wherein the container contents of the container to be emptied are emptied by the container emptying device onto a conveying device and/or into a collecting device.

The method according to the invention is characterized in that prior to, during and/or after the emptying of the container contents, data about the at least one container and/or the container contents are collected by means of at least one measuring device and the data thus collected are assigned to the container contents emptied onto the conveying device and/or into the collecting device. In other words, the data collected from at least one container and/or from the container contents are married or linked to the container contents on the conveying device or in the collecting device, so that at any later point in time, for example in a further process step, the container contents conveyed by the conveying device or the collecting device can be assigned to the previously collected data and, optionally, any further process actions can be adapted by means of these data. It is also conceivable that the previously collected data will be used for quality assurance and process monitoring.

This can be carried out, for example, by detecting the position of the conveying device on which the container contents were emptied in the event that emptying takes place onto a conveying device, but also, for example, by recognizing a code or number band on the conveying device or by transmitting the position of the point on the conveying device onto which the container contents were emptied at the point in time of emptying the corresponding container. It is also conceivable to detect the exact point in time of the emptying process and the subsequent assignment to the position on the conveying device, for example by detecting the motor position of the drive of the conveying device or the combination of the average transport time to the next process step, in the case of a conveyor belt.

In a further advantageous embodiment, the data collected by the measuring device can be made available to a data processing device, in particular a higher level control and monitoring system, for example a process control system, in order to ensure seamless monitoring and tracking of the material flow, even during the transition from piece goods to bulk goods.

Furthermore, the invention provides for the method that the collected data are transmitted to a production control system, a monitoring system and/or a quality assurance device. The invention preferably provides for the method that, on the basis of the collected data, instructions for action are derived, in particular for subsequent processes, for example further transport, processing, packaging, etc.

In a further advantageous embodiment of the method, the at least one container emptied by the container emptying device is transferred from the container emptying device to the container ejecting device, from which the at least one container is ejected from the apparatus.

Furthermore, the method according to the invention provides that the identity of the at least one container, at least one batch of containers and/or at least one pallet of containers is clearly determined by reading the identification element present on or in the at least one container, the at least one batch of containers and/or the at least one pallet of containers by means of an identification device.

In a further advantageous embodiment, during the ejection of at least one container by the container ejecting device, measurement data about the at least one container and its condition are collected. This means that if the container is damaged, for example, it can be rejected.

In order to ensure or avoid contamination of the container contents and/or of the at least one container, the method provides in a further advantageous embodiment that residues in the apparatus, in particular in the case of the container emptying device and/or the container conveying device, are removed by means of a cleaning unit after emptying the at least one container, at least one batch of containers and/or at least one pallet of containers.

Finally, in a third aspect, the invention provides that the apparatus according to the invention is used for emptying containers in a plant in the feed and/or food industry. The apparatus according to the invention is particularly preferably used in insect breeding.

The invention is explained below in more detail on the basis of an exemplary embodiment.

### BRIEF DESCRIPTION OF THE DRAWINGS

In the drawings:

FIG. 1: shows the exemplary embodiment in a schematic representation in a perspective view, along with

FIG. 2: the container emptying device according to FIG. 1 in a detailed view.

### DETAILED DESCRIPTION OF THE PREFERRED EMBODIMENTS

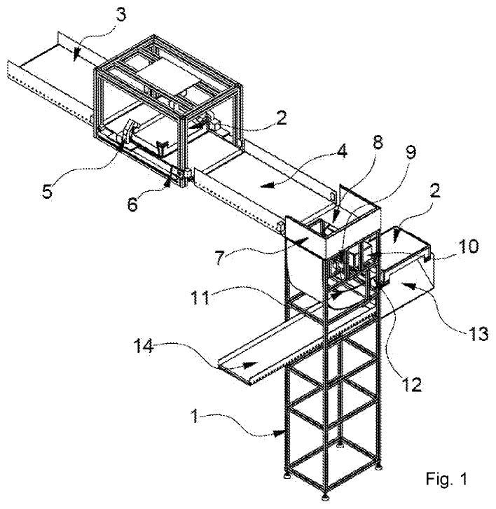

FIG. 1 shows a schematic representation of the exemplary embodiment of the apparatus according to the invention 1 in a perspective view. Here, the apparatus 1 comprises a container inserting device 4, a container emptying device 7 along with a container ejecting device 12. For transporting the containers 2 within the apparatus 1, the apparatus has a container conveying device 3, which is, for example, a conveyor belt.

In the exemplary embodiment shown here, the container inserting device 4 has a measuring device 5 arranged on the container inserting device 4 along with a weighing device 6. The weight of the container 2 can be determined using the weighing device 6. By means of the measuring device 5, any data, for example fill level, temperature, humidity, degree of maturity of insects, etc., about the container contents to be emptied and about the container 2 itself, for example the age of the container 2, existing damage, etc. can be collected. Here, it is also conceivable that the apparatus 1 has an identification device (not shown here) with which the containers 2 can be clearly identified and the data thus collected can be unequivocally assigned to the correct container 2 or the data for container identification are transferred from an upstream device to the apparatus 1.

Here, the collection of the data of the container 2 or the container contents is carried out by the measuring device 5 and the weighing device 6 during the conveyance of the container 2 by the container inserting device 4 in the direction of the container emptying device 7.

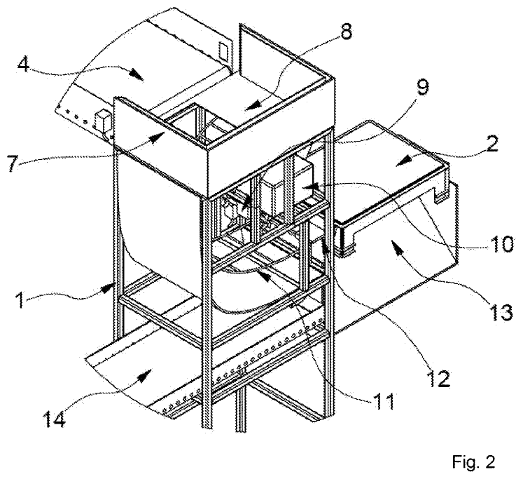

The container emptying device 7, shown in detail in FIG. 2, in this exemplary embodiment has a rotating device 8 for rotating the containers 2 conveyed by the container inserting device 4. Due to the rotation of the container 2 by 180° by means of the rotating device 8, the container contents emptied from the container 2 are directed via a guiding device 11 to a conveying device 14 arranged here below the container emptying device 7. The guiding device 11 serves to direct the emptied container contents onto the conveying device 14 on a targeted basis. Here, the conveying device 14 is, for example, also a conveyor belt like the container conveying device 3. However, it is also conceivable that the conveying device 14 is a driverless transport system that transports individual batches of emptied container contents.

In order to ensure that, when the container 2 is rotated by 180° by the rotating device 8, all of the container contents are emptied onto the conveying device 14, the container emptying device 7 here has a residue emptying device 9. Here, this has a shaking device (not shown in more detail), with which, for example, the container 2 rotated by 180° can be vibrated in order to release any container contents that are still stuck and to transfer them to the conveying device 14. In this exemplary embodiment, the container emptying device 7 also has a cleaning device 10, with which any residue still present within the container 2 can be removed.

During the emptying of the container 2 by the container emptying unit 7, the emptying process can be monitored before, during and after the emptying process by a measuring device 12 arranged here on the container emptying unit 7. It is conceivable that, with this measuring device 12, all data relevant for emptying, for example rotational speed of the rotating device 8, pouring speed of the container contents, grain size of the container contents, composition, volumes and quantity or number of the goods emptied and/or being emptied, color distribution, etc. can be measured.

If the container 2 has been emptied by the container emptying device 7 and the container contents have been transferred to the conveying device 14, the data previously collected by the measuring device 5 arranged on the container inserting device 4, the weighing device 6 and the measuring device 12 arranged on the emptying device 7 are assigned to the container contents located on the conveying device 14. In the case of a conveyor belt, this can be done, for example, by defining the position of the conveyor belt at the point in time of emptying the container 2 onto the conveyor belt, i.e. the conveying device 14. In the case of a driverless transport system, it is conceivable that the data of the emptied container 2 are assigned to the respective transport vehicle. Furthermore, emptying into a container arranged on the apparatus 1 is conceivable, which container can be transported away or further transported by a floor-bound or non-floor-bound conveyor system. The container contents ultimately obtained in this way can be fed together with the data assigned to the container contents to further process steps, for example to the treatment and processing of the container content, wherein in the further process steps the previously obtained data can be used as a basis for the further method or can be fed to different process steps according to the data situation, depending on the container content classification.

The container 2 emptied by the container emptying device 7 is subsequently transferred from the container emptying device 7 to the container ejecting device 13. Here, the container 2 is transferred to the container ejecting device 13 in its form rotated by 180°. This has the advantage that the step of turning the container 2 back to its starting position is eliminated, thus achieving greater efficiency and speed when emptying the container 2. The container 2, which has been emptied in this way and rotated by 180°, is examined in the container ejecting device 13 by means of a measuring device (not shown) arranged here on the container ejecting device 13 for, for example, residues or damage. Subsequently, the container 2 is ejected from the apparatus 1 by the container ejecting device 13 and can, for example, be fed to a cleaning device (not shown) for cleaning the container 2 if residues are present or can be disposed of if there is any damage.

Thus, an apparatus for emptying individual or palletized containers, in particular containers with insects, is disclosed above, with which a monitoring of the emptied container contents and/or the emptied container is made possible, as well as the detection of a wide variety of measurement data or measuring of a wide variety of parameters of a container and/or a container contents and the provision of these same data or parameters for monitoring, regulating and controlling downstream transport and handling and processing processes, as well as for quality assurance, process control and yield testing.

### LIST OF REFERENCE SIGNS

1 Apparatus
2 Container
3 Container conveying device
4 Container inserting device
5 Measuring device
6 Weighing device
7 Container emptying device
8 Rotating device
9 Residue emptying device
10 Cleaning device
11 Guiding device
12 Measuring device
13 Container ejecting device
14 Conveying device

1. An apparatus (1) for emptying individual or palletized containers (2), comprising a container inserting device (4) for inserting at least one container (2) to be emptied, a container emptying device (7) for emptying the at least one container (2), a container ejecting device (13) for ejecting the at least one emptied container (2), a container conveying device (3) for transporting the at least one container (2) to be emptied and/or emptied, and a conveying device (14) for transporting a container content emptied from the at least one container (2) and/or a collecting device for collecting the container contents emptied from the at least one container (2), characterized in that the apparatus (1) has at least one measuring device (5), by means of which data about the at least one container (2) and/or the container contents can be collected prior to, during and/or after the emptying of the at least one container (2), and the data collected by the at least one measuring device (5) can be assigned to the container contents emptied by the container emptying device (7) onto the conveying device (14) or into the collecting device.

2. The apparatus according to claim 1, characterized in that the data collected by the at least one measuring device (5) can be assigned to the at least one emptied container (2).

3. The apparatus according to claim 1, characterized in that the measuring device (5) has at least one sensor and/or at least one optical detecting device, in particular a camera, for collecting the data of the at least one container (2) to be emptied and/or the container contents.

4. The apparatus according to claim 1, characterized in that it has at least one weighing device (6) for weighing the at least one container (2) to be emptied and/or emptied.

5. The apparatus according to claim 1, characterized in that it is assigned at least one identification device, with which the identity of the at least one container (2), at least one batch of containers (2) and/or at least one pallet of containers (2) can be clearly determined via an identification element present on or in the at least one container (2), the at least one batch of containers (2) and/or at least one pallet of containers (2).

6. The apparatus according to claim 1, characterized in that it has an interface to a conveying and/or buffering device, in which the at least one container (2) to be emptied and/or emptied can be stored on an interim basis.

7. The apparatus according to claim 1, characterized in that it has an upstream and/or downstream container separating device for stacking and/or unstacking a container stack, a batch of containers (2) and/or a pallet of containers (2), with which unstacked containers (2) can be fed to the container conveying device (3) and/or emptied containers (2) can be received by the container conveying device (3).

8. The apparatus according to claim 1, characterized in that at least one measuring device (12) is arranged on the container ejecting device (13) for collecting measurement data of the at least one emptied container (2) and its condition, wherein the at least one measuring device (12) has at least one sensor and/or at least one optical detecting device, in particular a camera, for collecting the measurement data of the at least one emptied container (2).

9. The apparatus according to claim 1, characterized in that the container conveying device (3) is a device suitable for the continuous and/or discontinuous transport of at least one container (2), in particular a roller, belt, ball track or chain conveyor, a conveyor belt and/or a driverless transport system.

10. The apparatus according claim 1, characterized in that the container emptying device (7) has
a rotating device (8) for rotating the at least one container (2) to be emptied
and/or
a removal device, in particular a suction device, for removing the container contents from the at least one container to be emptied (2)
and/or
a residual emptying device (9) with which in particular any residue that may be present can be removed from the at least one emptied container (2), wherein the residual emptying device (9) is preferably a suction, shaking, tapping, vibration, high-pressure jet or brushing device or a combination of the aforementioned devices, with which any residue can be removed from the at least one emptied container (2).

11. The apparatus according to claim 1, characterized in that the container emptying device (7) has a guiding device (11) for guiding the container contents emptied from the at least one container (2) in the direction of the conveying device (14), wherein the guiding device (11) preferably has a lining and/or geometry, in particular a very steep, parabolically flattening angle, with which the container contents can be gently guided in the direction of the conveying device (14) and the impact of the container contents on the conveying device can be reduced
and/or
at least one flow device, with which the container contents can be conveyed to the conveying device (14) and/or collected by the conveying device (14) not exclusively gravimetrically, but in particular by vibration, hydraulics and/or pneumatics, wherein an impact of the container contents on the conveying device (14) can preferably be reduced and/or prevented by means of the flow device, in particular by forming an air cushion.

12. A method for emptying at least one container (2), in particular with an apparatus (1) according to claim 1,
characterized in that at least one container (2) to be emptied is conveyed by a container conveying device (3) and inserted into a container emptying device (7) by a container inserting device (4), and the at least one container (2) to be emptied is emptied in the container emptying device (7) onto a conveying device (14) and/or into a collecting device, and prior to, during and/or after the emptying of the at least one container (2), data about the at least one container (2) and/or the container contents are collected by means of at least one measuring device (5).

13. The method according to claim 12, characterized in that the data collected by the at least one measuring device (5) are assigned to the container contents emptied onto the conveying device (14) and/or into the collecting device and/or to the at least one emptied container (2).

14. The method according to claim 12, characterized in that the data collected by the at least one measuring device (5) are assigned to a position of the conveying device (14) at the point in time of emptying the container contents onto the conveying device (14).

15. The method according to claim 12, characterized in that the collected data are transmitted to at least one data processing device, in particular a data processing device of a process control system or downstream processes and/or systems, and/or to a production control system and/or to a monitoring system and/or to a quality assurance device.

16. The method according to claim 12, characterized in that instructions for action, in particular for subsequent processes, are derived from the collected data.

17. The method according to claim 12, characterized in that the at least one emptied container (2) is transferred from the container emptying device (7) to the container ejecting device (13) and the at least one emptied container (2) is ejected from the apparatus (1) by the container ejecting device (12).

18. The method according to claim 12, characterized in that the identity of the at least one container (2), at least one batch of containers (2) and/or at least one pallet of containers (2) is clearly determined by reading an identification element present on or in the at least one container (2), the at least one batch of containers (2) and/or the at least one pallet of containers (2) by means of an identification device.

19. The method according to claim 17, characterized in that, during the ejection of the at least one container (2) by the container ejecting device (13), measurement data about the at least one container (2) and its condition are collected.

20. The method according to claim 12, characterized in that, by means of a cleaning unit (10), residues in the apparatus (1), in particular in the container emptying device (7) and/or the container conveying device (3), are removed after emptying the at least one container (2), at least one batch of containers (2), and/or at least one pallet of containers (2).
